(19) United States
(12) Patent Application Publication
(10) Pub. No.: US 2024/0220317 A1
(43) Pub. Date: Jul. 4, 2024

(54) GRAPHICS PROCESSOR AND OPERATION METHOD OF GRAPHICS PROCESSOR

(71) Applicant: Alibaba Damo (Hangzhou) Technology Co., Ltd., Hangzhou (CN)

(72) Inventors: Haoran LI, Shanghai (CN); Fei SUN, San Jose, CA (US); Ruiguang ZHONG, Shanghai (CN); Yuan GAO, Shanghai (CN)

(21) Appl. No.: 18/394,657

(22) Filed: Dec. 22, 2023

(30) Foreign Application Priority Data
Dec. 29, 2022 (CN) 202211710142.8

(51) Int. Cl. G06F 9/48; G06F 9/50

(52) U.S. Cl. CPC G06F 9/4881; G06F 9/505

(57) ABSTRACT

An operation method of a graphics processor includes: dispatching multi-kernel respectively to multi-processing partition of the graphics processor to process the multi-kernel in parallel, the multi-processing partition comprising a first processing partition for processing a first kernel of the multi-kernel, and a second processing partition for processing a second kernel having a priority lower than a priority of the first kernel of the multi-kernel; determining whether the workload of the first processing partition meets a predetermined criterion; selecting the second processing partition as a donor processing partition according to kernel priority information when the workload of the first processing partition meets the predetermined criterion; and dispatching a thread block of the first kernel to a processing unit of the donor processing partition.

### CROSS-REFERENCE TO RELATED APPLICATIONS

The disclosure claims the benefits of priority to Chinese Application No. 202211710142.8, filed on Dec. 29, 2022, which is incorporated herein by reference in its entirety.

### TECHNICAL FIELD

The present disclosure relates to graphics processor, and more particularly to a graphics processor for dynamically dispatching processing units and an operation method of graphics processor.

### BACKGROUND

To improve the system utilization of a graphics processing unit (GPU), multiple workloads can run on the graphics processor concurrently, and a user can decide in advance how to dispatch different workloads to processing units on the graphics processor. However, different workloads have different priorities or performance goals, and each workload may also change over time. A conventional graphic processors may cause excessive delay time when high-priority workloads are being executed, degrading overall performance of the graphics processor.

### SUMMARY OF THE DISCLOSURE

Embodiments of the present disclosure provide a graphics processor. The graphics processor includes: a multi-processing partition configured to process multi-kernel in parallel, wherein each processing partition includes: a plurality of processing units, each processing unit comprising a computing unit and a storage block; and the multi-processing partition includes: a first processing partition for processing a first kernel of the multi-kernel; and a second processing partition for processing a second kernel having a priority lower than a priority of the first kernel of the multi-kernel; a controller configured to generate control information according to kernel priority information when workload of the first processing partition corresponding to the first kernel meets a predetermined criterion, the control information indicating that the second processing partition is selected as a donor processing partition; and a dispatch module coupled to the multi-processing partition and the controller, wherein the dispatched module is configured to: dispatch the first kernel to the first processing partition; and dispatch a thread block of the first kernel to a processing unit of the donor processing partition according to the control information when the workload of the first processing partition meets the predetermined criterion.

Embodiments of the present disclosure provide an operation method of a graphics processor. The method includes: dispatching multi-kernel respectively to multi-processing partition of the graphics processor to process the multi-kernel in parallel, the multi-processing partition comprising a first processing partition for processing a first kernel of the multi-kernel, and a second processing partition for processing a second kernel having a priority lower than a priority of the first kernel of the multi-kernel; determining whether the workload of the first processing partition meets a predetermined criterion; selecting the second processing partition as a donor processing partition according to kernel priority information when the workload of the first processing partition meets the predetermined criterion; and dispatching a thread block of the first kernel to a processing unit of the donor processing partition.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic view of an exemplary graphics processor, according to some embodiments of the present disclosure.

FIG. 2 is a schematic view of an exemplary graphics processor without dynamically dispatching processing units, according to some embodiments of the present disclosure.

FIG. 3 is a schematic view of an exemplary graphics processor after dynamically dispatching processing units, according to some embodiments of the present disclosure.

FIG. 4 is a flow chart of an exemplary method for dispatching processing units by a graphics processor, according to some embodiments of the present disclosure.

### DETAILED DESCRIPTION

Reference can now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims. Particular aspects of present disclosure are described in greater detail below. The terms and definitions provided herein control, if in conflict with terms and/or definitions incorporated by reference.

The conventional processing units dispatched to different workloads by the existing Graphics Processing Unit (GPU) have a fixed size, and the size of the processing units cannot be dynamically adjusted according to the priority of the workload or performance indicators. The overall systematic performance of the graphics processor is degraded when high-priority workloads experience excessively long delay time in execution because insufficient processing units have been dispatched to them.

Therefore, the present disclosure discloses a graphics processor and an operation method thereof, which can dynamically adjust the processing units dispatched to the workloads according to the priority of the workload or the performance indicator. The graphics processor and the operation method thereof will be further explained as follows.

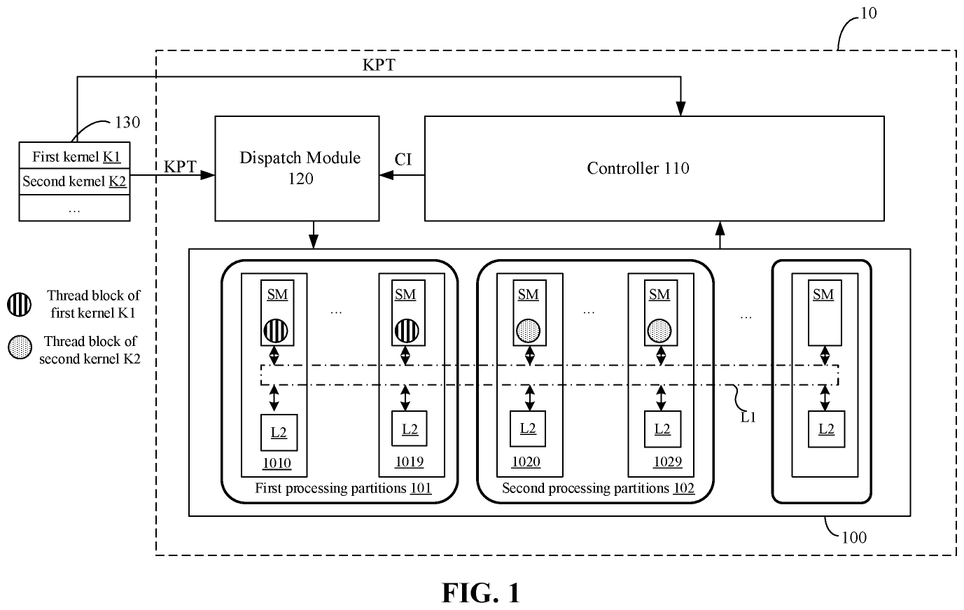

FIG. 1 is a schematic view of an exemplary graphics processor 10, according to some embodiments of the present disclosure. Graphics processor 10 may be a General-Purpose Computing on graphics processor (GPGPU) or other types of graphics processors. In the example shown in FIG. 1, graphics processor 10 may include a multi-processing partitions 100, a controller 110, and a dispatch module 120.

The multi-processing partition 100 is configured to process multi-kernel 130 in parallel, and the multi-processing partition 100 can be divided into various processing partitions (also called instances, e.g., a first processing partition 101, a second processing partition 102, etc.) according to user requirements. Each processing partition is configured to process a kernel of multi-kernel 130, and each processing partition (e.g., 101, 102) includes a plurality of processing units (also called slices, e.g., 1010, 1019, 1020, 1029). Each processing unit includes a computing unit SM (e.g., streaming multiprocessor) and storage blocks L1 and L2. Storage block 1 is a Crossbar (e.g., a cache memory) and is shared across all the processing units in the multi-processing partition 100. Storage block L2 is a specific memory (e.g., a graphic processing unit (GPU)). Each process unit may include one storage block L2. The computing unit SM can be configured to store a thread block of a kernel dispatched by dispatch module 120. For example, as shown in FIG. 1, multi-kernel 130 includes a plurality of kernels, for example, a first kernel K1 and a second kernel K2. Computing units of processing units 1010-1019 store thread blocks of the first kernel K1, and computing units of processing units 1020-1029 store thread blocks of the second kernel K2. The computing unit SM may be a streaming multiprocessor, which is not limited thereto. The storage blocks L1 and L2 may be caches. The storage block L1 may be included in all processing units (e.g., 1010, 1019, 1020, 1029) in the multi-processing partition 100, which is not limited thereto. In some embodiments, the storage block L1 (e.g., Crossbar) is used to connect the computing unit SM. Each processing unit including the computing unit SM, for example, a Graphics Processing Cluster (GPC), is connected by the storage block L1. For example, the data calculated by one GPC can be processed by another GPC, and such data allocation is performed via the Crossbar.

For the convenience of subsequent description, multi-processing partition 100 includes a first processing partition 101 to process the first kernel K1 of multi-kernel 130 and a second processing partition 102 to process the second kernel K2 of multi-kernel 130. First processing partition 101 includes processing units 1010-1019, and second processing partition 102 includes processing units 1020-1029.

Controller 110 is configured to, when the workload of first processing partition 101 corresponding to the first kernel K1 meets a predetermined criterion, generate control information CI indicating that second processing partition 102 of multi-processing partition 100 is selected as a donor processing partition according to kernel priority information in a kernel priority table (KPT) (received from multi-kernel 130). The kernel priority information KPT indicates priority information of each kernel of multi-kernel 130. Second processing partition 102 is configured to execute the second kernel K2, and a priority of the second kernel K2 is lower than a priority of the first kernel K1 of the multi-kernel 130. That is, graphics processor 10 can use multi-processing partition 100 to execute different kernels of multi-kernel 130 concurrently. When the workload of first processing partition 101 for executing the first kernel K1 having a high priority meets a predetermined criterion (for example, without limitation, excessively heavy workload and hence excessively long delay time), controller 110 can generate control information CI, indicating that second processing partition 102 for executing the second kernel K2 having a low priority is selected as the donor processing partition, according to the kernel priority information KPT, so that the processing unit in second processing partition 102 is donated to first processing partition 101 to execute the first kernel K1. In this case, first processing partition 101 that needs to borrow a processing unit from another processing partition is a borrower, and second processing partition 102 that donates its processing unit to another processing partition is a donor. The manner in which controller 110 determines that first processing partition 101 is a borrower and the manner in which controller 110 determines that second processing partition 102 is a donor will be described below. It should be noted that the kernel priority information KPT associated among the plurality of kernels of multi-kernel 130 can be set by the user of graphics processor 10, which is not limited thereto.

Dispatch module 120 is coupled to multi-processing partition 100 and controller 110 to dispatch the first kernel K1 to first processing partition 101, and when the workload of first processing partition 101 meets the predetermined criterion, dispatch module 120 is further configured to dispatch the thread block of the first kernel K1 to the processing unit of the donor processing partition according to the control information CI. That is, dispatch module 120 dispatches the thread block of each kernel to the processing unit. Depending on the dispatched thread block, the processing unit allocation information of each processing unit can indicate which processing partition the processing unit belongs to and which kernel the processing unit is used to execute. For example, processing units 1010-1019 are assigned to the thread blocks of the first kernel K1, and the processing unit allocation information of processing units 1010-1019 indicates that processing units 1010-1019 belong to first processing partition 101 for processing the first kernel K1 (in other words, processing units 1010-1019 form first processing partition 101). Processing units 1020-1029 are assigned to the thread blocks of the second kernel K2, and the processing unit allocation information of processing units 1020-1029 indicates that processing units 1020-1029 belong to second processing partition 102 for processing the second kernel K2 (in other words, processing units 1020-1029 form second processing partition 102).

When the workload of first processing partition 101 meets the predetermined criterion (for example, excessively heavy workload and hence excessively long delay time), based on second processing partition 102 indicated by the control information CI, dispatch module 120 dispatches the thread block of the first kernel K1 to the processing unit of the donor processing partition (i.e., second processing partition 102). For example, processing unit 1020 is originally assigned to the thread block of the second kernel K2, and the processing unit allocation information of processing unit 1020 indicates that processing unit 1020 belongs to second processing partition 102. When dispatch module 120 dispatches the thread block of the first kernel K1 to processing unit 1020, the processing unit allocation information of processing unit 1020 is updated to indicate that processing unit 1020 belongs to first processing partition 101.

The processing unit of the donor processing partition is a processing unit that is assigned to a thread block of the second kernel K2. In some embodiments, the processing unit of the donor processing partition is a processing unit that is not used to process the second kernel K2 in second processing partition 102. That is, the processing unit of second processing partition 102 (i.e., the donor processing partition) is assigned to the thread block of the second kernel K2, or not assigned to any thread block. Dispatch module 120 may dispatch the thread block of the first kernel K1 to the processing unit of the donor processing partition according to the number of processing units that need to be borrowed by the first processing partition 101 (i.e., the borrower). For example, dispatch module 120 may preferentially dispatch the thread block of the first kernel K1 to the processing unit that is not assigned to any thread block in second processing partition 102. Thereafter, if there is no processing unit in the second processing partition that is not assigned, dispatch module 120 dispatches the thread block of the first kernel K1 to the processing unit that is assigned to a thread block of the second kernel K2 in second processing partition 102.

Controller 110 is configured to estimate whether the delay time caused by using first processing partition 101 to complete execution of the first kernel K1 is greater than a predetermined time. When the estimated delay time is greater than the predetermined time, controller 110 determines that the workload of first processing partition 101 meets the predetermined criterion. For example, controller 110 may estimate the delay time when execution of all the thread blocks of the first kernel K1 has been completed based on the number of thread blocks of the first kernel K1 that have been executed currently, the number of all the thread blocks of the first kernel K1, and a total delay time of the thread blocks of the first kernel K1 that have been executed. When the estimated delay time is greater than the predetermined time (for example, it is greater than the delay time of the quality of service level by a critical value), controller 110 determines that the workload of first processing partition 101 meets the predetermined criterion (that is, the workload of first processing partition 101 is excessively heavy).

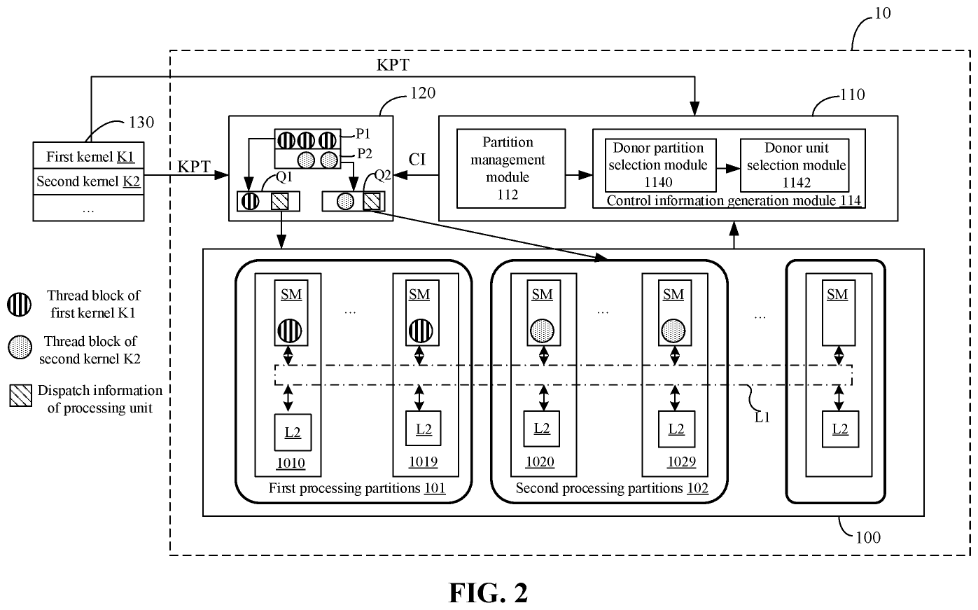

FIG. 2 is a schematic view of an exemplary graphics processor 10 without dynamically dispatching processing units, according to some embodiments of the present disclosure. In graphics processor 10 of FIG. 2, controller 110 further includes a first sub control unit (e.g., a first sub controller) configured to function as a partition management module 112 and a second sub control unit (e.g., a first sub controller) configured to function as a control information generation module 114. Partition management module 112 is configured to select first kernel K1 according to the kernel priority information KPT and to determine whether the workload of first processing partition 101 for executing the first kernel K1 meets a predetermined criterion. Control information generation module 114 is coupled to partition management module 112 and is configured to generate the control information CI according to at least the kernel priority information KPT when the workload of first processing partition 101 meets the predetermined criterion.

Control information generation module 114 is further configured to indicate that the processing unit in second processing partition 102 is selected as the processing unit of the donor processing partition. Control information generation module 114 further includes a donor partition selection module 1140 and a donor unit selection module 1142. Donor partition selection module 1140 is configured to select second processing partition 102 as the donor processing partition at least according to the kernel priority information KPT. Multi-kernel 130 further includes a third kernel (not shown in FIG. 2) having a priority equal to the priority of the second kernel K2, and the third kernel is dispatched to a third processing partition (not shown in FIG. 2) of multi-processing partition 100. According to kernel usage information, donor partition selection module 1140 further determines, through calculation, that the maximum number of thread blocks of the first kernel K1 that can be dispatched to second processing partition 102 is greater than the maximum number of thread blocks of the first kernel K1 that can be dispatched to the third processing partition, so as to select second processing partition 102 as the donor processing partition. The kernel usage information indicates the resource used for executing the first kernel K1. That is, in a group of processing units that execute kernels having the lowest priority in multi-kernel 130, according to the kernel usage information, donor partition selection module 1140 determines through calculation that the maximum number of thread blocks of the first kernel K1 can be dispatched to the processing partitions corresponding to the kernels, and second processing partition 102 determined through calculation is selected as the donor processing partition.

Donor unit selection module 1142 is coupled to donor partition selection module 1140. Donor unit selection module 1142 is configured to select the processing unit of second processing partition 102 as the processing unit of the donor processing partition and to generate control information CI accordingly. In some embodiments, donor unit selection module 1142 is configured to select a processing unit of second processing partition 102 as the processing unit of the donor processing partition according to processing unit performance information. The processing unit performance information indicates that a weight of a processing unit of second processing partition 102 is lower than a weight of another processing unit of second procession partition 102 in the processing operation of the second kernel K2. The processing operations of a kernel may include occupancy of the computing unit SM and bandwidth utility of the storage blocks L1 and L2 corresponding to each processing unit, which are not limited herein. The occupancy of the computing unit SM may be the ratio of the number of thread blocks currently running concurrently on the computing unit SM to the maximum number of thread blocks that can be running concurrently. In some embodiments, a weight indicates the occupancy of a computing unit SM. In some embodiments, the max number of processing units of the donor processing partition that can be borrowed is calculated based on the occupancy (e.g., resource usage).

For example, the processing units of the donor processing partition may include one or more idle processing units that are not assigned to any thread blocks in second processing partition 102. In some embodiments, according to the processing unit performance information, donor unit selection module 1142 may additionally select one or more low-performance processing units in processing partition 102 as the processing units of the donor processing partition, and the one or more low-performance processing units are those with performance lower than a critical value among the plurality of processing units that are assigned to thread blocks in second processing partition 102. Generally, once donor partition selection module 1140 has selected the donor processing partition (in this example, second processing partition 102), donor unit selection module 1142 will preferentially select the one or more idle processing units that are not assigned to any thread blocks in the donor processing partition as the processing units of the donor processing partition, so that the processing units that are originally assigned to the thread block of the second kernel K2 are not affected as much as possible. If the number of the one or more idle processing units is still insufficient to provide the number of processing units that need to be borrowed by the borrower (in this example, first processing partition 101), donor unit selection module 1142 further selects one or more additional low-performance processing units as processing units of the donor processing partition according to the processing unit performance information.

Dispatch module 120 may include multiple dispatch pipes and corresponding multiple dispatch queues. The multiple dispatch pipes are configured to store corresponding thread blocks of the plurality of kernels of multi-kernel 130, and the multiple dispatch queues are configured to receive the thread blocks from the multiple dispatch pipes and dispatch the thread blocks to the processing units according to the stored processing unit allocation information. The processing unit allocation information may indicate a group of processing units of a processing partition (e.g., processing partition 101) as a group of processing units for processing the corresponding kernel (e.g., the first kernel K1). In FIG. 2, the multiple dispatch pipes include a first dispatch pipe P1 for storing the thread blocks of the first kernel K1 and a second dispatch pipe P2 for storing the thread blocks of the second kernel K2. The multiple dispatch queues include a first dispatch queue Q1 for receiving the thread blocks of the first kernel K1 from the first dispatch pipe P1 and a second dispatch queue Q2 for receiving the thread blocks of the second kernel K2 from the second dispatch pipe P2.

Dispatch module 120 is configured to store processing unit allocation information that indicates a group of processing units of first processing partition 101 as a group of processing units for processing the first kernel K1. When the workload of first processing partition 101 meets the predetermined criterion, dispatch module 120 updates the processing unit allocation information according to the control information CI, and the updated processing unit allocation information indicates that the group of processing units for processing the first kernel K1 includes the processing units of the donor processing partition. That is, the donor processing unit of the donor processing partition is originally included in second processing partition 102, after the donor processing unit is selected by donor unit selection module 1142, dispatch module 120 updates the processing unit allocation information to indicate that the processing unit of the donor processing partition belongs to first processing partition 101 and is used to execute the first kernel K1.

After execution of the first kernel K1 is completed, dispatch module 120 resets the processing unit allocation information, and a group of processing units of first processing partition 101 serves as a group of processing units for processing the first kernel K1. That is, after first processing partition 101 that borrowed the processing unit of another processing partition, due to the workload meeting the predetermined criterion, has completed execution of the first kernel K1, the processing unit originally borrowed from the donor processing partition (i.e., second processing partition 102) to first processing partition 101 must be returned to the donor processing partition (i.e., second processing partition 102). In this case, dispatch module 120 resets the donor processing unit allocation information to indicate that the processing unit of the donor processing partition belongs to second processing partition 102 and can execute the second kernel K2.

When the processing unit of second processing partition 102 is selected as the processing unit of the donor processing partition, dispatch module 120 stops dispatching the thread block of the second kernel K2 to the donor processing unit of second processing partition 102. That is, after the processing unit of the donor processing partition is borrowed by another processing partition, dispatch module 120 will not dispatch the thread block of the second kernel K2 to the donor processing unit of second processing partition 102 before execution of the kernel (i.e., the first kernel K1) corresponding to the borrower (i.e., first processing partition 101) is completed. In other words, the donor processing unit cannot be used to execute the second kernel K2 until execution of the first kernel K1 is completed.

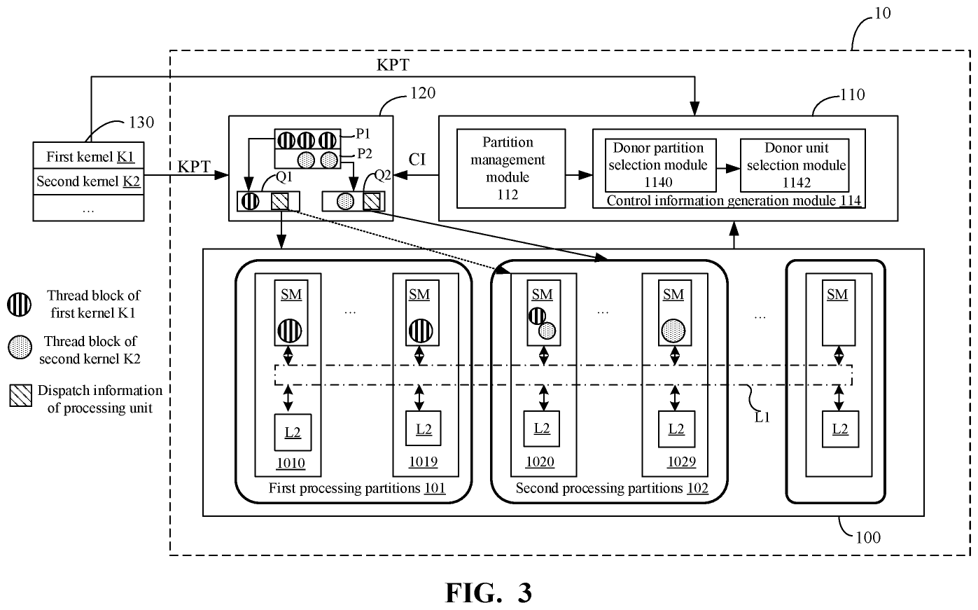

FIG. 3 is a schematic view of another exemplary graphics processor 10 after dynamically dispatching processing units, according to some embodiments of the present disclosure. Refer to FIG. 2 and FIG. 3, Graphics processor 10 shown in FIG. 2 illustrates an initial multi-processing partition 100 and processing units included in graphic processor 10 without dynamic dispatch of processing units. Graphics processor 10 shown in FIG. 3 illustrates multi-processing partition 100 and the processing units included in the processing partitions, after dynamic dispatch of processing units.

Referring to FIG. 2, in graphics processor 10 of FIG. 2, dispatch module 120 dispatches the thread blocks of the kernels to the processing units according to the kernel priority information KPT of multi-kernel 130 and updates the processing unit allocation information of the processing units. When graphics processor 10 is running, partition management module 112 of controller 110 determines that the workload of first processing partition 101 for executing the first kernel K1 having a higher priority meets a predetermined criterion. According to the determination of partition management module 112, donor partition selection module 1140 in control information generation module 114 selects second processing partition 102 as the donor processing partition according to the kernel usage information, and donor unit selection module 1142 selects processing unit 1020 in second processing partition 102 as the donor processing unit according to the processing unit performance information. Then referring to FIG. 3, according to the control information CI indicating the processing unit of the donor processing partition received from controller 110, dispatch module 120 dispatches the thread block of the first kernel K1 to processing unit 1020 selected by donor unit selection module 1142, and updates the processing unit allocation information of processing unit 1020 so that the processing unit allocation information of processing unit 1020 indicates processing unit 1020 is in first processing partition 101. As shown in FIG. 3, first processing partition 101 for executing the first kernel K1 includes not only original processing units 1010-1019, but also processing unit 1020 borrowed from second processing partition 102.

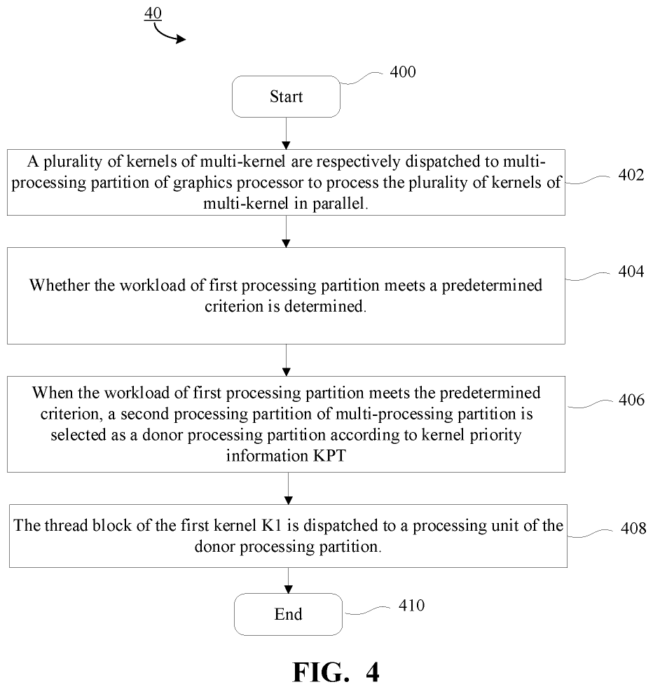

FIG. 4 is a flow chart illustrating an exemplary method 40 of dispatching processing units by graphics processor 10, according to some embodiments of the present disclosure. Referring to FIG. 4 and consistent with FIG. 1 to FIG. 3, method 40 includes steps 400 to 410.

At step 400, the method is started.

At step 402, a plurality of kernels of multi-kernel 130 are respectively dispatched to multi-processing partition 100 of graphics processor 10 to process the plurality of kernels of multi-kernel 130 in parallel. Multi-processing partition 100 includes a first processing partition 101 for processing a first kernel K1 of multi-kernel 130.

At step 404, whether the workload of first processing partition 101 meets a predetermined criterion is determined.

At step 406, when the workload of first processing partition 101 meets the predetermined criterion, a second processing partition 102 of multi-processing partition 100 is selected as a donor processing partition according to kernel priority information KPT. Second processing partition 102 is used to execute the second kernel K2, a priority of the second kernel K2 being lower than a priority of the first kernel K1.

At step 408, the thread block of the first kernel K1 is dispatched to a processing unit of the donor processing partition.

At step 410, the method is ended.

In some embodiments, the processing unit of the donor processing partition is a processing unit that is assigned to the thread block of the second kernel K2, or a processing unit that is not assigned to any thread block of the second kernel K2 in the second processing partition 102.

In some embodiments, in step 404, determining whether the workload of first processing partition 101 meets a predetermined criterion further includes: estimating whether a delay time caused by using the first processing partition to complete execution of the first kernel is greater than a predetermined time; and when the estimated delay time is greater than the predetermined time, determining that the workload of the first processing partition meets the predetermined criterion.

In some embodiments, method 40 further includes: selecting the first kernel K1 from multi-kernel 130 according to the kernel priority information KPT.

In some embodiments, multi-kernel 130 includes a third kernel having a priority equal to the priority of the second kernel K2, and the third kernel is dispatched to a third processing partition of the multi-processing partition 100. In step 406, selecting second processing partition 102 as the donor processing partition according to the kernel priority information KPT further includes: determining through calculation that the maximum number of thread blocks of the first kernel K1 that can be dispatched to second processing partition 102 is greater than the maximum number of thread blocks of the first kernel K1 that can be dispatched to the third processing partition according to the kernel usage information, where the kernel usage information indicates the resources used to execute the first kernel K1; and selecting second processing partition 102 as the donor processing partition. In some embodiments, method 40 further includes: selecting the processing unit of second processing partition 102 as the processing unit of the donor processing partition according to processing unit performance information, where the processing unit performance information indicates that the processing unit of second processing partition 102 has a lower weight in the processing operation of the second kernel K2 than the weight that another processing unit of second processing partition 102 has in the processing operation of the second kernel K2.

In some embodiments, in step 408, dispatching the thread block of the first kernel K1 to the processing unit of the donor processing partition includes: dispatching the thread block of the first kernel K1 to the processing unit of the donor processing unit according to the processing unit allocation information. The processing unit allocation information indicates that the group of processing units for processing the first kernel K1 includes the processing unit of the donor processing partition. The processing unit allocation information indicates that before the thread block of the first kernel K1 is dispatched to the processing unit of the donor processing partition, the group of processing units for processing the first kernel K1 all come from first processing partition 101. In this case, method 40 further includes: after execution of the first kernel K1 is completed, resetting the processing unit allocation information, the processing unit allocation information indicating that the group of processing units for processing the first kernel K1 all come from first processing partition 101.

In some embodiments, when the processing unit of second processing partition 102 is selected as the donor processing unit of the donor processing partition, method 40 further includes: prohibiting dispatching of the thread block of the second kernel K2 to the processing unit of second processing partition 102 which is selected as the donor processing unit.

It can be understood that the processing unit, the controller, and the modules in the present disclosure may include one or more processors, and a processor may be an electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), a neural processing unit (NPU), and any other type circuit capable of data processing. The processor may also be a virtual processor that includes one or more processors distributed across multiple machines or devices coupled via a network.

To sum up, in the graphics processor of the present disclosure, the processing partitions can be divided to execute the kernels according to the priorities of different kernels, and when the workload of the processing partition for executing a higher-priority kernel meets a predetermined criterion, the processing unit is dynamically dispatched from another processing partition for executing a lower-priority kernel to the above-mentioned processing partition, so that the overall usage efficiency of the graphics processor is improved.

The embodiments may further be described using the following clauses:

1. A graphics processor, comprising:
a multi-processing partition configured to process multi-kernel in parallel, wherein each processing partition comprises: a plurality of processing units, each processing unit comprising a computing unit and a storage block; and the multi-processing partition comprises:
   a first processing partition for processing a first kernel of the multi-kernel; and
   a second processing partition for processing a second kernel having a priority lower than a priority of the first kernel of the multi-kernel;
a controller configured to generate control information according to kernel priority information when workload of the first processing partition corresponding to the first kernel meets a predetermined criterion, the control information indicating that the second processing partition is selected as a donor processing partition; and
a dispatch module coupled to the multi-processing partition and the controller, wherein the dispatched module is configured to:
   dispatch the first kernel to the first processing partition; and
   dispatch a thread block of the first kernel to a processing unit of the donor processing partition according to the control information when the workload of the first processing partition meets the predetermined criterion.

2. The graphics processor according to clause 1, wherein the processing unit of the donor processing partition is a processing unit that is assigned to a thread block of the second kernel in the second processing partition.

3. The graphics processor according to clause 1, wherein the processing unit of the donor processing partition is a processing unit that is not assigned to a thread block of the second kernel in the second processing partition.

4. The graphics processor according to clause 1, wherein the controller is configured to: estimate whether a delay time is greater than a predetermined time, the delay time caused by using the first processing partition to complete execution of the first kernel; and when the estimated delay time is greater than the predetermined time, determine that the workload of the first processing partition meets the predetermined criterion.

5. The graphics processor according to clause 1, wherein the controller comprises:
a partition management module configured to:
   select the first kernel according to the kernel priority information; and
   determine whether the workload of the first processing partition for executing the first kernel meets the predetermined criterion; and
a control information generation module coupled to the partition management module, and configured to:
   generate the control information at least according to the kernel priority information when the workload of the first processing partition meets the predetermined criterion.

6. The graphics processor according to clause 5, wherein the control information further indicates that a first processing unit in the second processing partition is selected as the processing unit of the donor processing partition, and the control information generation module comprises:
a donor partition selection module configured to select the second processing partition as the donor processing partition at least according to the kernel priority information; and
a donor unit selection module coupled to the donor partition selection module, and configured to select the first processing unit of the second processing partition as the processing unit of the donor processing partition and generate the control information accordingly.

7. The graphics processor according to clause 6, wherein the multi-kernel comprises a third kernel having a priority equal to the priority of the second kernel, and the third kernel is dispatched to a third processing partition of the multi-processing partition; the donor partition selection module is further configured to:
determine through calculation that a maximum number of thread blocks of the first kernel that can be dispatched to the second processing partition is greater than a maximum number of thread blocks of the first kernel that can be dispatched to the third processing partition according to kernel usage information, the kernel usage information indicating resources used to execute the first kernel; and
select the second processing partition as the donor processing partition.

8. The graphics processor according to clause 6, wherein the donor unit selection module is configured to select the first processing unit of the second processing partition as the processing unit of the donor processing partition according to processing unit performance information, the processing unit performance information indicating that a weight of the first processing unit of the second processing partition is lower than a weight of another processing unit of the second processing partition in processing operation of the second kernel.

9. The graphics processor according to clause 1, wherein the dispatch module is configured to:
store processing unit allocation information that indicates a group of processing units of the first processing partition as a group of processing units for processing the first kernel; and
update the processing unit allocation information according to the control information when the workload of the first processing partition meets the predetermined criterion, wherein the group of processing units for processing the first kernel comprises the processing unit of the donor processing partition.

10. The graphics processor according to clause 9, wherein after execution of the first kernel is completed, the dispatch module is configured to reset the processing unit allocation information, and the group of processing units of the first processing partition serves as the group of processing units for processing the first kernel.

11. The graphics processor according to clause 6, wherein when the first processing unit of the second processing partition is selected as the processing unit of the donor processing partition, the dispatch module is configured to stop dispatching the thread block of the second kernel to the first processing unit of the second processing partition.

12. An operation method of a graphics processor, comprising:
dispatching multi-kernel respectively to multi-processing partition of the graphics processor to process the multi-kernel in parallel, the multi-processing partition comprising a first processing partition for processing a first kernel of the multi-kernel, and a second processing partition for processing a second kernel having a priority lower than a priority of the first kernel of the multi-kernel;
determining whether the workload of the first processing partition meets a predetermined criterion;
selecting the second processing partition as a donor processing partition according to kernel priority information when the workload of the first processing partition meets the predetermined criterion; and
dispatching a thread block of the first kernel to a processing unit of the donor processing partition.

13. The operation method according to clause 12, wherein the processing unit of the donor processing partition is a processing unit that is assigned to a thread block of the second kernel in the second processing or a processing unit that is not assigned to a thread block of the second kernel in the second processing partition.

14. The operation method according to clause 12, wherein determining whether the workload of the first processing partition meets the predetermined criterion further comprises:
estimating whether a delay time caused by using the first processing partition to complete execution of the first kernel is greater than a predetermined time; and
when the estimated delay time is greater than the predetermined time, determining that the workload of the first processing partition meets the predetermined criterion.

15. The operation method according to clause 12, further comprising:
selecting the first kernel from the multi-kernel according to the kernel priority information.

16. The operation method according to clause 12, wherein the multi-kernel comprises a third kernel having a priority equal to the priority of the second kernel, the third kernel being dispatched to a third processing partition of the multi-processing partition; and selecting the second processing partition as the donor processing partition according to the kernel priority information further comprises:
determining through calculation that a maximum number of thread blocks of the first kernel that can be dispatched to the second processing partition is greater than a maximum number of thread blocks of the first kernel that can be dispatched to the third processing partition according to kernel usage information, the kernel usage information indicating resources used to execute the first kernel; and selecting the second processing partition as the donor processing partition.

17. The operation method according to clause 12, further comprising:
selecting a first processing unit of the second processing partition as the processing unit of the donor processing partition according to processing unit performance information, wherein the processing unit performance information indicates that a weight of the first processing unit of the second processing partition is lower than a weight of another processing unit of the second processing partition in processing operation of the second kernel.

18. The operation method according to clause 12, wherein dispatching the thread block of the first kernel to the processing unit of the donor processing partition further comprises:
dispatching the thread block of the first kernel to the processing unit of the donor processing partition according to processing unit allocation information, wherein the processing unit allocation information indicates that a group of processing units for processing the first kernel comprises the processing unit of the donor processing partition; and
wherein before the thread block of the first kernel is dispatched to the processing unit of the donor processing partition, the processing unit allocation information indicates that the group of processing units for processing the first kernel all come from the first processing partition.

19. The operation method according to clause 18, further comprising:
after execution of the first kernel is completed, resetting the processing unit allocation information to indicate the group of processing units for processing the first kernel all come from the first processing partition.

20. The operation method according to clause 17, wherein when the first processing unit of the second processing partition is selected as the processing unit of the donor processing partition, the method further comprises:
prohibiting dispatching the thread block of the second kernel to the first processing unit of the second processing partition.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It should be understood that the disclosed technical content may be implemented in other ways. The apparatus embodiments described above are only schematic. For example, the division of the units is only a logical function division. In actual implementations, there may be another division manner. For example, multiple units or components may be combined or integrated into another system, or some features can be ignored or not implemented. In addition, the displayed or discussed mutual coupling or direct coupling or communication connection may be indirect coupling or communication connection through some interfaces, units, or modules, which may be in electrical or other forms.

The units described as separate components may or may not be physically separated, and the components displayed as units may or may not be physical units, that is, they may be located in one place or may be distributed to a plurality of network units. Part of or all the units may be selected according to actual needs to achieve the purpose of the solution of the present embodiment.

In addition, the functional units in various embodiments of the present disclosure may be integrated into one processing unit, or each unit may exist alone physically, or two or more units may be integrated into one unit. The integrated units described above may be implemented either in the form of hardware or in the form of a software functional unit.

The above are only preferred implementations of the present disclosure. It should be pointed out that, for those of ordinary skill in the art, several improvements and retouches may further be made without departing from the principles of the present disclosure. These improvements and retouches should also be regarded as the scope of protection of the present specification.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A graphics processor, comprising:
a multi-processing partition configured to process multi-kernel in parallel, wherein each processing partition comprises: a plurality of processing units, each processing unit comprising a computing unit and a storage block; and the multi-processing partition comprises:
a first processing partition for processing a first kernel of the multi-kernel; and
a second processing partition for processing a second kernel having a priority lower than a priority of the first kernel of the multi-kernel;
a controller configured to generate control information according to kernel priority information when workload of the first processing partition corresponding to the first kernel meets a predetermined criterion, the control information indicating that the second processing partition is selected as a donor processing partition; and
a dispatch module coupled to the multi-processing partition and the controller, wherein the dispatched module is configured to:
dispatch the first kernel to the first processing partition; and
dispatch a thread block of the first kernel to a processing unit of the donor processing partition according to the control information when the workload of the first processing partition meets the predetermined criterion.

2. The graphics processor according to claim 1, wherein the processing unit of the donor processing partition is a processing unit that is assigned to a thread block of the second kernel in the second processing partition.

3. The graphics processor according to claim 1, wherein the processing unit of the donor processing partition is a processing unit that is not assigned to a thread block of the second kernel in the second processing partition.

4. The graphics processor according to claim 1, wherein the controller is configured to:
estimate whether a delay time is greater than a predetermined time, the delay time caused by using the first processing partition to complete execution of the first kernel; and
when the estimated delay time is greater than the predetermined time, determine that the workload of the first processing partition meets the predetermined criterion.

5. The graphics processor according to claim 1, wherein the controller comprises:
a partition management module configured to:
select the first kernel according to the kernel priority information; and
determine whether the workload of the first processing partition for executing the first kernel meets the predetermined criterion; and
a control information generation module coupled to the partition management module, and configured to:
generate the control information at least according to the kernel priority information when the workload of the first processing partition meets the predetermined criterion.

6. The graphics processor according to claim 5, wherein the control information further indicates that a first processing unit in the second processing partition is selected as the processing unit of the donor processing partition, and the control information generation module comprises:
a donor partition selection module configured to select the second processing partition as the donor processing partition at least according to the kernel priority information; and
a donor unit selection module coupled to the donor partition selection module, and configured to select the first processing unit of the second processing partition as the processing unit of the donor processing partition and generate the control information accordingly.

7. The graphics processor according to claim 6, wherein the multi-kernel comprises a third kernel having a priority equal to the priority of the second kernel, and the third kernel is dispatched to a third processing partition of the multi-processing partition; the donor partition selection module is further configured to:
determine through calculation that a maximum number of thread blocks of the first kernel that can be dispatched to the second processing partition is greater than a maximum number of thread blocks of the first kernel that can be dispatched to the third processing partition according to kernel usage information, the kernel usage information indicating resources used to execute the first kernel; and
select the second processing partition as the donor processing partition.

8. The graphics processor according to claim 6, wherein the donor unit selection module is configured to select the first processing unit of the second processing partition as the processing unit of the donor processing partition according to processing unit performance information, the processing unit performance information indicating that a weight of the first processing unit of the second processing partition is lower than a weight of another processing unit of the second processing partition in processing operation of the second kernel.

9. The graphics processor according to claim 1, wherein the dispatch module is configured to:
store processing unit allocation information that indicates a group of processing units of the first processing partition as a group of processing units for processing the first kernel; and
update the processing unit allocation information according to the control information when the workload of the first processing partition meets the predetermined criterion, wherein the group of processing units for processing the first kernel comprises the processing unit of the donor processing partition.

10. The graphics processor according to claim 9, wherein after execution of the first kernel is completed, the dispatch module is configured to reset the processing unit allocation information, and the group of processing units of the first processing partition serves as the group of processing units for processing the first kernel.

11. The graphics processor according to claim 6, wherein when the first processing unit of the second processing partition is selected as the processing unit of the donor processing partition, the dispatch module is configured to stop dispatching the thread block of the second kernel to the first processing unit of the second processing partition.

12. An operation method of a graphics processor, comprising:
dispatching multi-kernel respectively to multi-processing partition of the graphics processor to process the multi-kernel in parallel, the multi-processing partition comprising a first processing partition for processing a first kernel of the multi-kernel, and a second processing partition for processing a second kernel having a priority lower than a priority of the first kernel of the multi-kernel;
determining whether a workload of the first processing partition meets a predetermined criterion;
selecting the second processing partition as a donor processing partition according to kernel priority information when the workload of the first processing partition meets the predetermined criterion; and
dispatching a thread block of the first kernel to a processing unit of the donor processing partition.

13. The operation method according to claim 12, wherein the processing unit of the donor processing partition is a processing unit that is assigned to a thread block of the second kernel in the second processing or a processing unit that is not assigned to a thread block of the second kernel in the second processing partition.

14. The operation method according to claim 12, wherein determining whether the workload of the first processing partition meets the predetermined criterion further comprises:
estimating whether a delay time caused by using the first processing partition to complete execution of the first kernel is greater than a predetermined time; and
when the estimated delay time is greater than the predetermined time, determining that the workload of the first processing partition meets the predetermined criterion.

15. The operation method according to claim 12, further comprising:
selecting the first kernel from the multi-kernel according to the kernel priority information.

16. The operation method according to claim 12, wherein the multi-kernel comprises a third kernel having a priority equal to the priority of the second kernel, the third kernel being dispatched to a third processing partition of the multi-processing partition; and selecting the second processing partition as the donor processing partition according to the kernel priority information further comprises:
determining through calculation that a maximum number of thread blocks of the first kernel that can be dispatched to the second processing partition is greater than a maximum number of thread blocks of the first kernel that can be dispatched to the third processing partition according to kernel usage information, the kernel usage information indicating resources used to execute the first kernel; and
selecting the second processing partition as the donor processing partition.

17. The operation method according to claim 12, further comprising:
selecting a first processing unit of the second processing partition as the processing unit of the donor processing partition according to processing unit performance information, wherein the processing unit performance information indicates that a weight of the first processing unit of the second processing partition is lower than a weight of another processing unit of the second processing partition in processing operation of the second kernel.

18. The operation method according to claim 12, wherein dispatching the thread block of the first kernel to the processing unit of the donor processing partition further comprises:
dispatching the thread block of the first kernel to the processing unit of the donor processing partition according to processing unit allocation information, the processing unit allocation information indicating that a group of processing units for processing the first kernel comprises the processing unit of the donor processing partition; wherein before the thread block of the first kernel is dispatched to the processing unit of the donor processing partition, the processing unit allocation information indicates that the group of processing units for processing the first kernel all come from the first processing partition.

19. The operation method according to claim 18, further comprising:
after execution of the first kernel is completed, resetting the processing unit allocation information to indicate the group of processing units for processing the first kernel all come from the first processing partition.

20. The operation method according to claim 17, wherein when the first processing unit of the second processing partition is selected as the processing unit of the donor processing partition, the method further comprises:
prohibiting dispatching the thread block of the second kernel to the first processing unit of the second processing partition.
